(19) United States
(12) Patent Application Publication
(10) Pub. No.: US 2010/0041544 A1
(43) Pub. Date: Feb. 18, 2010

(54) Electrode Catalyst of Carbon Nitride Nanotubes Supported by Platinum and Ruthenium Nanoparticles and Preparation Method Thereof

(75) Inventors: Zheng Hu, Jiangsu (CN); Yanwen Ma, Jiangsu (CN); Bing Yue, Jiangsu (CN); Leshu Yu, Jiangsu (CN)

Correspondence Address: GLOBAL IP SERVICES, 7285 W. Eagle Court, Winton, CA, 95388, US

(73) Assignee: NANJING UNIVERSITY, Nanjing, Jiangsu (CN)

(21) Appl. No.: 12/524,561

(22) PCT Filed: May 12, 2008
(86) PCT No.: PCT/CN08/70936

§ 371 Date: Jul. 24, 2009

(30) Foreign Application Priority Data
May 10, 2007 (CN) 200710022235.0

(51) Int. Cl. H01M 4/88; B01J 27/24

(52) U.S. Cl. 502/101; 502/174; 977/810

(57) ABSTRACT

Electrode catalyst of carbon nitride nanotubes supported by platinum and ruthenium nanoparticles have been produced by a simple, rapid, effective and green process: taking use of the affinity of carbon nitride nanotubes to platinum and ruthenium atoms, Pt and Ru nanoparticles could be directly deposited on carbon nitride nanotubes by the reduction reaction, hereby avoiding the pre-activation or modification process needed by carbon nanotubes. The electrode catalysts produced in this way are suitable for proton exchange membrane fuel cells or direct methanol fuel cells, as well as other chemical reactions catalyzed by Pt and Ru.

### CROSS REFERENCE TO RELATED PATENT APPLICATION

The present patent application is the US national stage of PCT/CN2008/070936 filed on May 12, 2008, which claims the priority of the Chinese patent application No. 200710022235.0 filed on May 10, 2007, which is incorporated herein by reference.

### BACKGROUND OF THE INVENTION

1. Field of the Invention

The invention relates to carbon nitride nanotube supported electrode catalyst: platinum and ruthenium nanoparticles and their preparation method.

2. Discussion of the Prior Art

Carbon nanotubes are ideal catalyst support for electrode catalysis in fuel cells by virtue of their large surface area, high electrical conductivity and good chemical stability. Carbon nanotube supported Pt, Ru and their alloy nanoparticles have been widely researched. Testing shows that these electrode catalysts exhibit good performance in proton exchange membrane fuel cells and direct methanol fuel cells, indicating their important potential applications in battery technology [see H. Liu, et al. J. Power Sources 155 (2006) 95]. However, the carbon nanotubes that are currently using in scale are mixtures of conductors and semiconductors. Ultra-pure metallic (conducting) carbon nanotubes for electrode catalysis are hard to obtain. Also, carbon nanotubes need to be chemically modified when they act as support to immobilize Pt, Ru and other metal nanoparticles because carbon is chemically inert. The chemical modification increases the processing difficulty and preparing cost, and causes environmental pollution. Therefore, it is a challenging topic to resolve the stated issues of carbon nanotubes.

Carbon nitride nanotubes, also called nitrogen-doped carbon nanotubes, are prepared by doping nitrogen atoms in the graphitic carbon lattices by the formation of C—N bonds. Carbon nitride nanotubes have higher conductivity than carbon nanotubes since the nitrogen atoms in carbon nitride nanotubes provide additional electrons [see R. Czerw, et al. Nano Lett. 1 (2001) 457]. Recent research reveals that carbon nitride nanotubes act as Lewis base, and may be used to catalyze the oxygen reduction reaction in fuel cells [see S. Maldonado, et al. J. Phys. Chem. 109 (2005) 4707]. The unique properties of carbon nitride nanotubes have received much research attention. Using the intrinsic chemical reactivity of carbon nitride nanotubes, A. Zamudio et al have directly deposited Ag nanoparticles onto carbon nitride nanotubes without pre-modification [see A. Zamudio, et al. Small 2 (2006) 346]. The results of their study demonstrate that carbon nitride nanotubes are better electrode catalyst support than carbon nanotubes because they possess large surface area, high electrical conductivity, good stability, intrinsic capacity for catalysis and metal nanoparticle immobilization. Therefore, it is important to develop the preparation method of carbon nitride nanotube supported Pt and Ru nanoparticles for both theoretical and practical purposes.

### SUMMARY OF THE INVENTION

The object of the present invention is to provide a new method of depositing Pt, Ru and their alloyed nanoparticles on carbon nitride nanotubes to produce electrode catalyst with high specific area, high conductivity, good stability and excellent catalytic properties.

The invention provides an electrode catalyst made of carbon nitride nanotube supported Pt and Ru nanoparticles. The carbon nitride nanotubes of the invention are multi-walled, single-walled or a mixture of both types, having the nitrogen content of 0.01-1.34 in N/C ratios, denoted as CNₓ, wherein x is equal to 0.01-1.34. The Pt and Ru nanoparticles have diameters of 0.1-15 nm, and their content in the composite catalyst are 1%-100% (wt %) with respect to the weight of the supporting carbon nitride nanotubes.

This invention provides a method for preparing carbon nitride nanotube supported Pt and Ru nanoparticles containing the following steps: carbon nitride nanotubes are evenly dispersed into the solution of platinum and ruthenium salts; the salts are reduced by reducing agents, forming carbon nitride nanotube supported Pt and Ru nanoparticles; the electrode catalyst of carbon nitride nanotube supported Pt and Ru nanoparticles is obtained after purification.

The molar ratio of platinum and ruthenium salts is m:n, wherein m=0-1, n=0-1, and m and n cannot simultaneously be equal to 0. Namely, when m (or n) is 0, n (or m) is 1. The platinum salt is chloroplatinic acid, potassium chloroplatinate or platinum acetate. The ruthenium salt is ruthenium chloride or potassium chlororuthenate.

The reducing agent used in this invention is ethylene glycol, sodium borohydride, potassium borohydride or hydrogen. The reducing procedure varies according to the selected reducing agent. When ethylene glycol is used, carbon nitride nanotubes are dispersed into ethylene glycol solution containing platinum and ruthenium salts, then the temperature is increased to about 100-180° C. and maintained for about 0.5-5 h. When sodium borohydride is used as the reducing agent, carbon nitride nanotubes are dispersed into aqueous solution containing platinum and ruthenium salts, then sodium borohydride solution (about 0.005-0.03 mol/L) and sodium hydroxide solution (about 0.01-0.15 mol/L) were added into the salt solution till the pH of the whole system reaches 10-12, allowing about 0.5-3 h for the reaction. When hydrogen is used as the reducing agent, carbon nitride nanotubes are dispersed into aqueous solution containing platinum and ruthenium salts, then filtrated and dried at room temperature. The solid product is reduced by hydrogen at about 250-40° C. for about 1-4 h.

The invention provides a method to directly deposit Pt and Ru nanoparticles onto carbon nitride nanotubes without pre-modification, making use of the inherent chemical of carbon nitride nanotubes.

The electrode catalysts produced using this invention are suitable for proton exchange membrane fuel cells or direct methanol fuel cells, as well as other chemical reactions catalyzed by Pt and Ru.

The electrode catalytic properties of methanol oxidation for the obtained carbon nitride nanotube supported Pt and Ru nanoparticles were studied in a CHI 660A workstation.

The feature of the invention is to provide a simple, rapid, effective and environmentally friendly method to prepare electrode catalysts, making use of the affinity of carbon nitride nanotubes to platinum and ruthenium atoms. In this invention, Pt and Ru nanoparticles could be directly deposited on carbon nitride nanotubes, thereby avoiding the pre-activation or modification of carbon nanotubes.

### BRIEF DESCRIPTION OF THE DRAWINGS

The invention is described below in greater detail with reference to the accompanying drawings, wherein:

FIG. 1 is the transmission electron micrograph (TEM) image of carbon nitride nanotubes.

FIG. 2 is the TEM image of carbon nitride nanotube supported Pt—Ru nanoparticles.

FIG. 3 shows the X-ray diffraction (XRD) pattern of carbon nitride nanotube supported Pt—Ru nanoparticles.

FIG. 4 is the TEM image of carbon nitride nanotube supported Pt nanoparticles.

FIG. 5 is the high-resolution TEM (HRTEM) image of carbon nitride nanotube supported Pt nanoparticles.

FIG. 6 shows energy dispersive X-ray spectrometry (EDS) of carbon nitride nanotube supported Pt nanoparticles.

### EXAMPLE 1

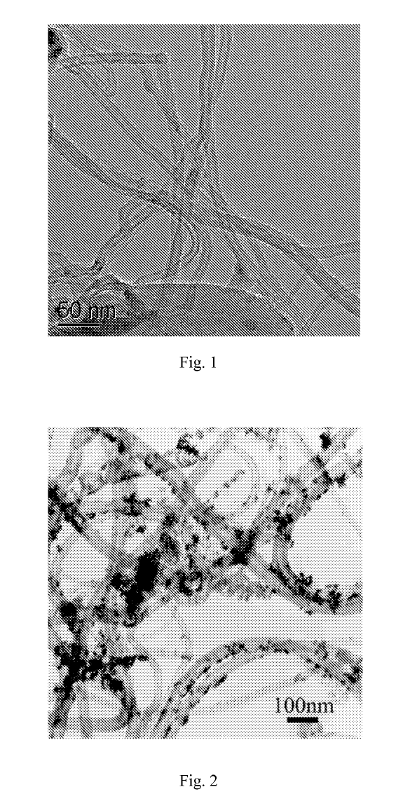

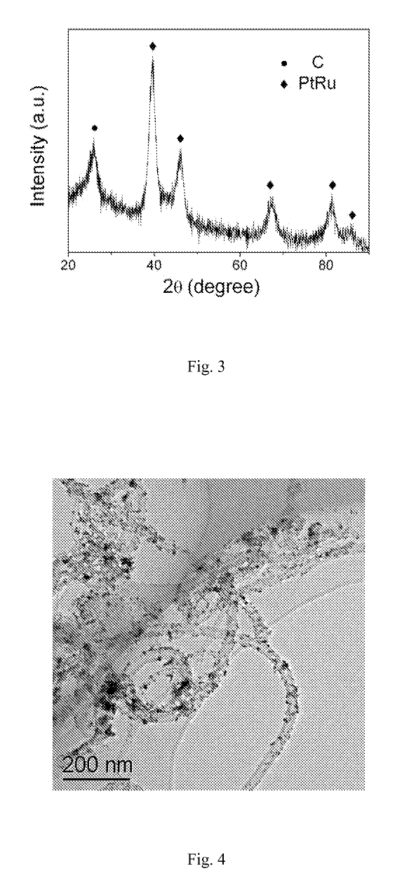

0.1 g carbon nitride nanotubes were dispersed in 50 mL ethylene glycol solution of mixed H₂PtCl₆ and RuCl₃ (molar ratio 1:1) containing 0.015 g Pt and 0.008 g Ru. The solution was stirred for 4 h with nitrogen gas protection, then heated to 140° C. (usually between 100 to 180° C.) and maintained for 3 h (usually between 0.5 to 5 h). After reaction, the solid product was collected by filtration and vacuum-dried at 60° C., denoted as Pt_{1.0}Ru_{1.0}/CNₓ TEM image in FIG. 2 shows that Pt—Ru nanoparticles have the diameters of 1-15 nm. XRD pattern in FIG. 3 displays the peaks for Pt—Ru alloy, which is in accordance with the result in the literature [L. Li and Y. Xing, J. Phys. Chem. C 111 (2007) 2803]. Inductively coupled plasma-atomic emission spectrometry measurement confirms that the supported nanoparticles are composed of platinum and ruthenium with molar ratio of 1:1. Similar experimental results were obtained when the support of multi-walled, single-walled or mixed nanotubes were used.

### EXAMPLE 2

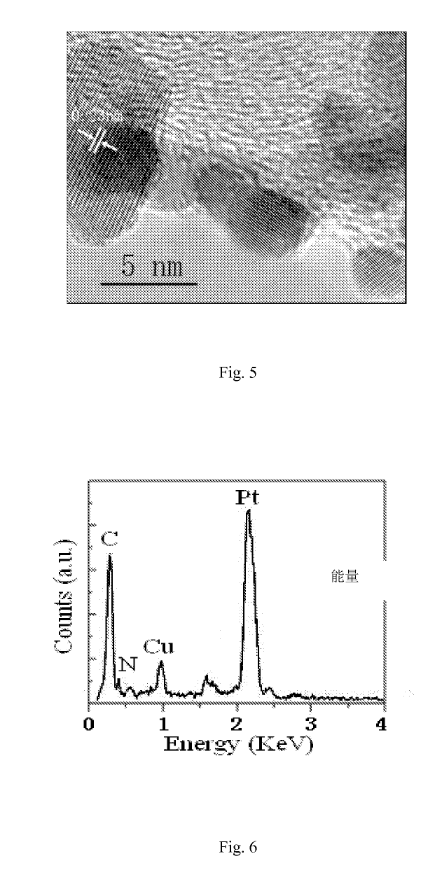

0.1 g carbon nitride nanotubes were dispersed in 50 mL ethylene glycol solution of H₂PtCl₆ containing 0.015 g Pt and stirred for 4 h under nitrogen gas protection, then heated to 140° C. and maintained for 3 h. After reaction, the solid product was collected by filtration and vacuum-dried at 60° C., denoted as Pt/CNₓ. TEM image in FIG. 4 shows that Pt nanoparticles have the diameters of 1-15 nm. The characterization results of HRTEM image (FIG. 5) and EDS (FIG. 6) indicate that the supported nanoparticles are Pt nanoparticles. Similar results were obtained when H₂PtCl₆ is replaced by platinum acetate. Carbon nitride supported Ru nanoparticles when a single precursor, potassium chlororuthenate, was used.

### EXAMPLE 3

0.1 g carbon nitride nanotubes were dispersed in 50 mL aqueous solution of mixed H₂PtCl₆ and RuCl₃ (molar ratio of 1:1) containing 0.015 g Pt and 0.008 g Ru and stirred for 4 h under nitrogen protection, then mixed sodium borohydride solution (about 0.005-0.03 mol/L) and sodium hydroxide solution (about 0.01-0.15 mol/L) were added into the above solution till the pH value of the whole system reached about 10-12. After 0.5-3 h of reaction, the product similar to EXAMPLE 1 was obtained.

### EXAMPLE 4

0.1 g carbon nitride nanotubes were dispersed in 50 mL aqueous solution of mixed H₂PtCl₆ and RuCl₃ (molar ratio 1:1) containing 0.015 g Pt and 0.008 g Ru and stirred for 4 h, then filtrated and dried at room temperature. The solid sample obtained in this way was reduced by hydrogen at about 250-400° C. for about 1-4 h. After the sample was cooled to room temperature under hydrogen gas protection, the product similar to EXAMPLE 1 was obtained.

### EXAMPLE 5

0.1 g carbon nitride nanotubes were placed in 30 mL aqueous solution of RuCl₃ containing 0.008 g Ru and sonicated for 5 min, then the pH value was adjusted to 4 by adding sodium hydroxide and appropriate amounts of hydrogen peroxide solution. After 3 min reaction, the solid was collected by repeated filtration-washing process and vacuum-dried at 60° C., denoted as RuO₂.xH₂O/CNₓ. The sample obtained in this way was dispersed in 50 mL ethylene glycol solution of H₂PtCl₆ containing 0.015 g Pt and stirred for 4 h under nitrogen gas protection, then heated to 140° C. and maintained for 3 h. After reaction, the solid was collected by filtration and vacuum-dried at 60° C., denoted as Pt/RuO₂.xH₂O/CNₓ.

What is claimed is:

1. Electrode catalyst of carbon nitride nanotube supported by platinum and ruthenium nanoparticles, wherein the carbon nitride nanotubes of the invention are multi-walled, single-walled or a mixture of both types, having the nitrogen content of 0.01-1.34 in N/C ratios, denoted as CNₓ, wherein x is equal to 0.01-1.34. The Pt and Ru nanoparticles have diameters of 0.1-15 nm, and their content in the composite catalyst are 1%-100% (wt %) with respect to the weight of the supporting carbon nitride nanotubes.

2. The electrode catalyst of carbon nitride nanotubes supported by platinum and ruthenium nanoparticles of claim 1, wherein the carbon nitride nanotubes are multi-walled nanotubes or single-walled nanotubes or mixed nanotubes of the multi-walled nanotubes and the single-walled nanotubes.

3. A process for producing electrode catalyst of carbon nitride nanotubes supported by platinum and ruthenium nanoparticles comprising the following steps:
carbon nitride nanotubes are evenly dispersed into a solution of platinum and ruthenium salts;
the platinum and ruthenium salts are reduced by reductant, forming carbon nitride nanotube supported Pt and Ru nanoparticles; the electro catalyst of carbon nitride nanotubes supported by Pt and Ru nanoparticles is obtained after purification.

4. The process of claim 3, wherein the platinum salt is chloroplatinic acid, potassium chloroplatinate or platinum acetate, and the ruthenium salt is ruthenium chloride or potassium chlororuthenate, a mole ratio for platinum and ruthenium metals salts is m:n, wherein m=0-1, n=0-1, and m and n both cannot simultaneously be equal to 0.

5. The process of claim 3, wherein the reductant is ethylene glycol, sodium borohydride, potassium borohydride or hydrogen; when the ethylene glycol is used as the reductant, the carbon nitride nanotubes are dispersed into ethylene glycol solution containing platinum and ruthenium salts, then temperature is increased to about 100-180° C. and maintained for about 0.5-5 h; when the sodium borohydride is used as the reductant, the carbon nitride nanotubes are dispersed into aqueous solution containing platinum and ruthenium salts, then sodium borohydride solution (about 0.005-0.03 mol/L) and sodium hydroxide solution (about 0.01-0.15 mol/L) are added into the aqueous solution containing platinum and ruthenium salts, till the pH of the whole solution reaches 10-12, allowing about 0.5-3 h for the reaction, then filtrated and dried at room temperature; when hydrogen is used as the reducing agent, the carbon nitride nanotubes are dispersed into aqueous solution containing platinum and ruthenium salts, the solid product is reduced by hydrogen at about 250-400° C. for about 1-4 h.

6. The process of claim 4, wherein stirred for 4 h under nitrogen gas protection.
